(19) United States
(12) Patent Application Publication
(10) Pub. No.: US 2018/0141247 A1
(43) Pub. Date: May 24, 2018

(54) METHOD OF MANUFACTURING LIQUID SUPPLY UNIT AND METHOD OF MANUFACTURING LIQUID EJECTING HEAD

(71) Applicant: CANON KABUSHIKI KAISHA, Tokyo (JP)

(72) Inventors: Noriyasu Nagai, Tokyo (JP); Yukuo Yamaguchi, Tokyo (JP); Toshiaki Hirosawa, Hiratsuka-shi (JP); Hiromasa Amma, Kawasaki-shi (JP); Soji Kondo, Yokohama-shi (JP); Takuya Iwano, Inagi-shi (JP)

(21) Appl. No.: 15/794,232

(22) Filed: Oct. 26, 2017

(30) Foreign Application Priority Data
Nov. 24, 2016 (JP) 2016-228084

(51) Int. Cl. B29C 45/00; B41J 2/16; B29C 65/02

(52) U.S. Cl. CPC B29C 45/006; B41J 2/1637; B29K 2081/04; B41J 2/1648; B29C 65/02; B41J 2/1623

(57) ABSTRACT

In a molding step, at least a first member, which constitutes a liquid supply unit together with a second member, is injection molded by using an injection mold including first and second molds being made openable and closable. In a mold opening step, the first and second molds are opened while leaving the first member, which is injection molded in the molding step, on the first mold. In a first bonding step, a third member constituting the liquid supply unit is bonded to the first member left on the first mold.

### BACKGROUND OF THE INVENTION

### Field of the Invention

The present invention relates to a method of manufacturing a liquid supply unit to supply a liquid such as an ink, and a method of manufacturing a liquid ejecting head capable of ejecting a liquid such as an ink.

### Description of the Related Art

Japanese Patent Laid-Open No. 2001-63053 describes a liquid ejecting head of a so-called serial type. This liquid ejecting head is formed from a printing element board, passage plates, a tank holder to mount an ink tank, a passage forming member, a filter, and the like. The passage plates, the passage forming member, and the filter collectively function as a liquid supply unit for supplying a liquid to the liquid ejecting head. The passage plates are joined to the tank holder by an adhesive or the like, and the passage forming member is joined to the holder by ultrasonic welding. The filter is provided between the ink tank and the holder, and prevents entry of dust from outside.

When the relatively short liquid ejecting head described in Japanese Patent Laid-Open No. 2001-63053 is applied to an elongated liquid ejecting head of a line type, it is necessary to provide an elongated passage forming member that corresponds to the length of the liquid ejecting head. When the elongated passage forming member as described above is produced by injection molding of a resin, the passage forming member is at risk of developing a significant change in shape due to cure shrinkage, torsion, warpage or the like of the passage forming member at or after detachment from a mold. In the meantime, in the process of producing the liquid supply unit, a lid member or the like needs to be bonded to the passage forming member so as to avoid a leakage of the liquid from a passage formed in the passage forming member. However, it is difficult to bond the lid member or the like to the elongated passage forming member having changed in shape so as to avoid the leakage of the liquid from the passage. Meanwhile, when the area of the filter is increased in order to suppress passage resistance, it is also difficult to bond the filter to the elongated passage forming member having changed in shape.

### SUMMARY OF THE INVENTION

The present invention provides methods of manufacturing a liquid supply unit and a liquid ejecting head, which are capable of suppressing a change in shape of a component constituting a liquid supply unit after injection molding of the component, and of bonding a different component constituting the liquid supply unit to the component.

In the first aspect of the present invention, there is provided a method of manufacturing a liquid supply unit to form a liquid passage to supply a liquid to a liquid ejecting head, comprising:

a molding step of injection molding at least a first member, which constitutes the liquid supply unit together with a second member, by using an injection mold including first and second molds being made openable and closable;

a mold opening step of opening the first and second molds while leaving the first member, which is injection molded in the molding step, on the first mold; and

a first bonding step of bonding a third member constituting the liquid supply unit to the first member left on the first mold.

In the second aspect of the present invention, there is provided a method of manufacturing a liquid ejecting head provided with a liquid supply unit, comprising:

a molding step of injection molding at least a first member, which constitutes the liquid supply unit together with a second member, by using an injection mold including first and second molds being made openable and closable;

a mold opening step of opening the first and second molds while leaving the first member, which is injection molded in the molding step, on the first mold;

a first bonding step of bonding a third member constituting the liquid supply unit to the first member left on the first mold; and

a second bonding step of bonding the second member to the first member having the third member bonded thereto in the first bonding step; and

a third bonding step of bonding a printing element board, which is configured to eject a liquid, to the members bonded in the second bonding step.

According to the present invention, it is possible to suppress a change in shape of a component constituting a liquid supply unit after injection molding of the component by leaving the component on a mold, and to bond a different component constituting the liquid supply unit to the component in that state.

Further features of the present invention will become apparent from the following description of exemplary embodiments with reference to the attached drawings.

### BRIEF DESCRIPTION OF THE DRAWINGS

FIG. 1 is a schematic perspective view of a liquid ejecting apparatus according to a first embodiment of the present invention;

FIG. 2 is a schematic diagram of an ink circulation passage in the liquid ejecting apparatus;

FIGS. 3A and 3B are perspective views of the liquid ejecting head of FIG. 1 viewed from different directions from each other;

FIG. 4 is an exploded perspective view of the liquid ejecting head;

FIG. 5 shows explanatory diagrams of front surfaces and back surfaces of first, second, and third passage members constituting the liquid ejecting head;

FIG. 6 is a transparent perspective view for explaining connection relations among passages in the liquid ejecting head;

FIG. 7 is a cross-sectional view taken along the VII-VII line in FIG. 6;

FIGS. 8A and 8B are perspective views of an ejecting module according to the present invention, respectively;

FIGS. 9A, 9B, and 9C are explanatory diagrams of a printing element board, respectively;

FIG. 10 is a cross-sectional view taken along the X-X line in FIG. 9A;

FIG. 11 is a plan view of abutting portions of the printing element boards;

FIGS. 12A, 12B, and 12C are exploded perspective views for explaining different configuration examples of the liquid supply unit, respectively;

FIGS. 13A and 13B are explanatory diagrams of a mold, respectively;

FIGS. 14A, 14B, and 14C are cross-sectional views for explaining a manufacturing process for the liquid supply unit, respectively;

FIGS. 15A and 15B are explanatory diagrams of a mold in a second embodiment of the present invention, respectively;

FIG. 16 shows cross-sectional views for explaining a manufacturing process for a liquid supply unit according to a second embodiment of the present invention;

FIG. 17 is an explanatory diagram of a mold according to a third embodiment of the present invention; and

FIG. 18 is a cross-sectional view of a substantial part of a liquid supply unit.

### DESCRIPTION OF THE EMBODIMENTS

Embodiments of the present invention will be described below with reference to the drawings.

### First Embodiment

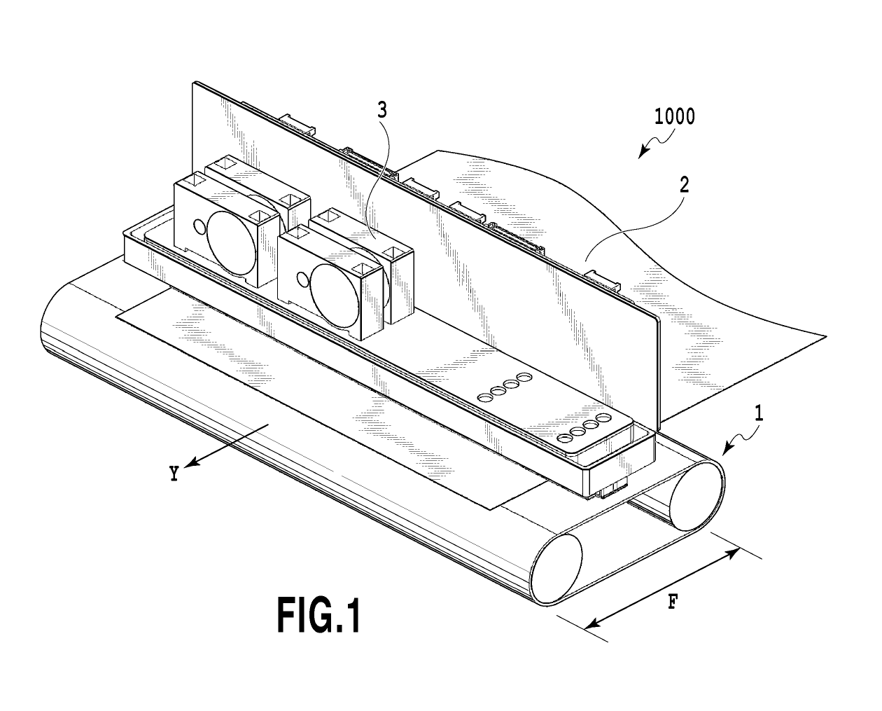

FIGS. 1 to 14C are diagrams for explaining a first embodiment of the present invention. A liquid ejecting apparatus of this embodiment represents an example of application to an inkjet printing apparatus, which is configured to print an image by ejecting an ink as a liquid from an inkjet printing head serving as a liquid ejecting head.

### (Configuration Example of Liquid Ejecting Apparatus)

FIG. 1 is a schematic configuration diagram of an inkjet printing apparatus 1000 (hereinafter also referred to as the “printing apparatus”) of this embodiment. The printing apparatus 1000 includes a conveyance unit 1 which conveys a printing medium 2 in a conveyance direction of an arrow Y, and a liquid ejecting head 3 of a line type disposed in such a way as to extend in a direction intersecting (at right angle in this example) with the conveyance direction of the printing medium 2. The printing apparatus 1000 of this embodiment is a line-type printing apparatus which continuously prints images on printing medium 2 while conveying the printing medium 2 either continuously or intermittently. The printing medium 2 are not limited only to cut sheet but may also be continuous rolled sheet. The liquid ejecting head 3 can print full-color images by ejecting inks of cyan (C), magenta (M), yellow (Y), and black (K). Supply paths, main tanks, and buffer tanks for supplying the inks to the liquid ejecting head 3 are connected to the liquid ejecting head 3. Moreover, an electric control unit for sending electric power and ink ejection control signals to the liquid ejecting head 3 is connected to the liquid ejecting head 3. The inks and a route for the electric signals in the liquid ejecting head 3 will be described later.

### (Ink Circulation Passage)

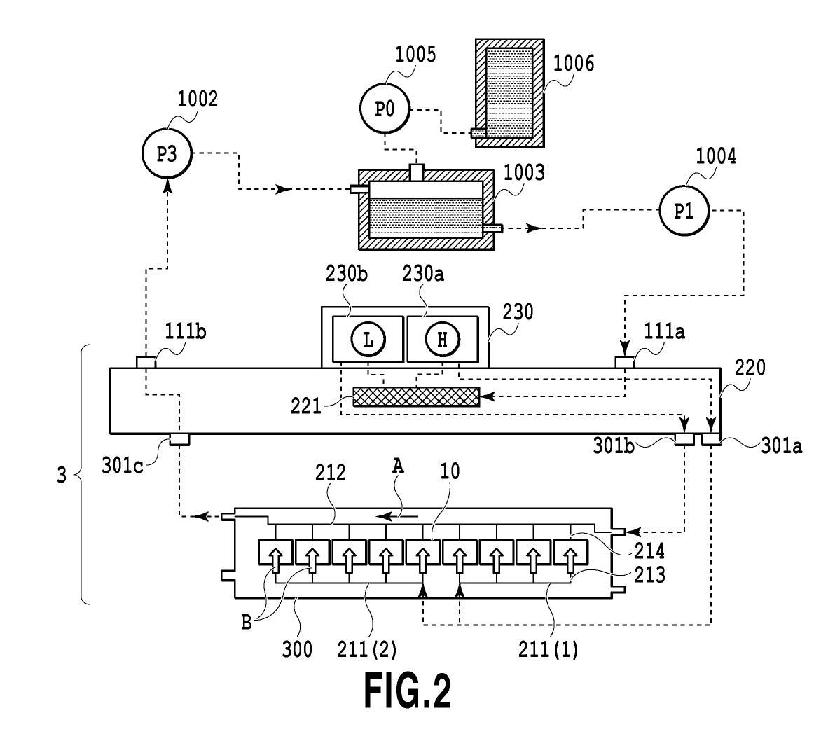

FIG. 2 is a schematic diagram of an ink circulation passage applicable to the printing apparatus 1000. The liquid ejecting head 3 is fluidically connected to a first circulation pump (P3) 1002, a buffer tank 1003, and the like. In order to simplify the explanation, FIG. 2 illustrates only a circulation passage for one of the inks of C, M, Y, and K. In fact, the ink circulation passages for the four colors and the liquid ejecting heads 3 corresponding thereto are provided to a body of the printing apparatus. The buffer tank 1003 serving as a subtank to be connected to a main tank 1006 includes an atmosphere communication port (not shown) which establishes communication between the inside and outside thereof, so that the atmosphere communication port can discharge bubbles in the inks to the outside. A replenishing pump 1005 connected to the buffer tank 1003 replenishes the buffer tank 1003 with the ink from the main tank 1006 in an amount equivalent to that consumed by the liquid ejecting head 3. The ink is consumed by ejection from the liquid ejecting head 3 during printing, and by discharge during recovery processing (such as suction recovery and preliminary ejection) to maintain a good state of ink ejection.

The first circulation pump 1002 suctions the ink in the liquid ejecting head 3 and sends the ink to the buffer tank 1003 through an outflow port 301c and a liquid connector 111b. A positive displacement pump having a quantitative liquid pumping capacity is suitable for the first circulation pump 1002. Specific examples thereof include a tube pump, a gear pump, a diaphragm pump, a syringe pump, and the like. For instance, it is possible to use a pump configured to secure a constant flow rate by disposing a general constant flow rate valve or a general relief valve at an outlet of the pump. During the drive of the liquid ejecting head 3, the first circulation pump 1002 feeds a certain amount of the ink into a common circulation passage 212 in a direction of an arrow A. A flow rate of the ink is preferably set to such an amount as to suppress a difference in temperature between printing element boards 10 in the liquid ejecting head 3 to the extent not affecting image quality of a printed image. If the flow rate is too large, a negative pressure difference of the ink between the printing element boards 10 may become too large due to an effect of a pressure loss in the passage inside a liquid ejecting unit 300, and may cause density unevenness in an image. In this regard, it is preferable to set the flow rate while taking into account the difference in temperature and the difference in negative pressure between each pair of printing element boards 10.

A negative pressure control unit 230 is provided on a passage between a second circulation pump (P1) 1004 and the liquid ejecting unit 300. The negative pressure control unit 230 has a function to maintain an ink pressure on a downstream side (the liquid ejecting unit 300 side) of the negative pressure control unit 230 at a preset constant pressure even if a flow rate in the ink circulation system fluctuates in response to an image printing duty. Each of two pressure regulating mechanisms 230a and 230b constituting the negative pressure control unit 230 may apply any mechanism as long as such a mechanism can control the pressure downstream thereof within a certain range centered on a desired setting pressure. For example, each of the pressure regulating mechanisms 230a and 230b may adopt a mechanism similar to a so-called “pressure reducing regulator”. When the pressure reducing regulators are used, it is preferable to apply a pressure to the upstream side of the negative pressure control unit 230 through a liquid supply unit 220 by using the second circulation pump 1004 as shown in FIG. 2. In this way, it is possible to suppress an effect of a water head pressure from the buffer tank 1003 to the liquid ejecting head 3, and thus to increase the freedom of layout of the buffer tank 1003 in the printing apparatus 1000. The second circulation pump 1004 only needs to have a lifting pressure that is equal to or above a certain pressure in a range of an ink circulation flow rate used during the drive of the liquid ejecting head 3, so that any one of a turbo pump, a positive displacement pump, and the like is applicable. Specifically, a diaphragm pump and the like are applicable. Alternatively, instead of the second circulation pump 1004, it is possible to apply a water head tank disposed in such a way as to establish a certain water head difference with respect to the negative pressure control unit 230, for example. The ink is introduced from the second circulation pump 1004 into the negative pressure control unit 230 through a liquid connector 111a and a filter 221.

The negative pressure control unit 230 in FIG. 2 includes the two pressure regulating mechanisms 230a and 230b with setting pressures that are different from each other. The pressure regulating mechanism (H) 230a having a relatively high setting pressure is connected to a common supply passage 211 (211(1) and 211(2)) in the liquid ejecting unit 300 through a liquid passage in the liquid supply unit 220 and through an inflow port 301a. Meanwhile, the pressure regulating mechanism (L) 230b having a relatively low setting pressure is connected to a common collection passage 212 in the liquid ejecting unit 300 through the liquid passage in the liquid supply unit 220 and through an inflow port 301b. The common supply passage 211, the common collection passage 212, individual supply passages 213, and individual collection passages 214 are formed in the liquid ejecting unit 300. The individual supply passages 213 communicate individually with multiple pressure chambers in the respective printing element boards 10 while the individual collection passages 214 communicate individually with the multiple pressure chambers in the respective printing element boards 10. The individual supply passages 213 communicate with the common supply passage 211 while the individual collection passages 214 communicate with the common collection passage 212. The ink in the common supply passage 211 is controlled at a relatively high pressure by the pressure regulating mechanism 230a, while the ink in the common collection passage 212 is controlled at a relatively low pressure by the pressure regulating mechanism 230b. As described above, a prescribed difference in pressure is set between the common supply passage 211 and the common collection passage 212, and the ink in the common collection passage 212 is suctioned by the first circulation pump 1002. As a consequence, the ink in the common supply passage 211 flows to the common collection passage 212 while being passed through the multiple pressure chambers of the printing element boards 10 in a direction of an arrow B via the individual supply passages 213 and the individual collection passages 214.

As described above, the flow of the ink which is fed from the common supply passage 211, passed through the pressure chambers of the respective printing element boards 10, and collected by the common collection passage 212, and the flow of the ink passed through the common collection passage 212 in the direction of the arrow A are generated in the liquid ejecting unit 300. The ink flowing from the common supply passage 211 to the common collection passage 212 through the individual supply passages 213 and the individual collection passages 214 can discharge heat generated in each printing element board 10 to the outside. Moreover, the flow of the ink can also be created in a pressure chamber which does not eject the ink during a printing operation by the liquid ejecting head 3. Accordingly, it is possible to suppress thickening of the ink at an ink ejecting port corresponding to the pressure chamber. In addition, a thickened ink or a foreign matter in the ink can be discharged to the outside through the common collection passage 212. As a consequence, the liquid ejecting head 3 of this embodiment can print high-quality images at a high speed.

### (Configuration of Liquid Ejecting Head)

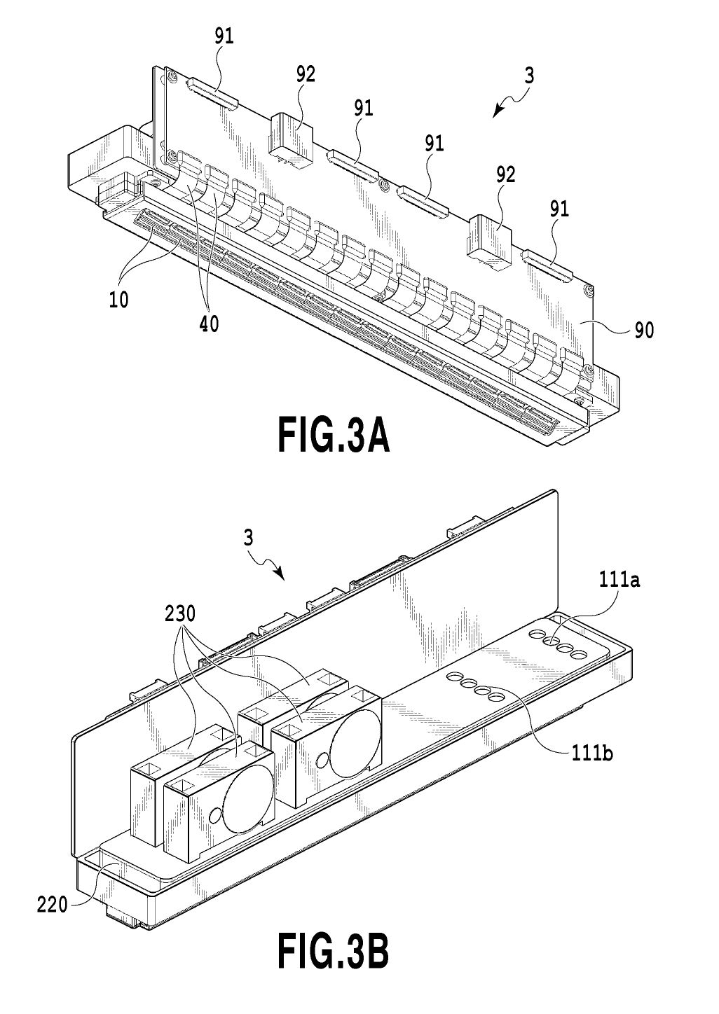

FIGS. 3A and 3B are perspective views of the liquid ejecting head 3 of this embodiment, respectively. The liquid ejecting head 3 of this embodiment is a liquid ejecting head of a line type in which fifteen printing element boards 10 are arranged in alignment (disposed in line). Here, each printing element board 10 is capable of ejecting the inks of four colors of C, M, Y, and K. Four negative pressure control units 230 in total are installed to correspond to the inks of four colors, respectively. As shown in FIG. 3A, each printing element board 10 is electrically connected to one of signal input terminals 91 and one of power supply terminals 92 through a flexible wiring substrate 40 and an electric wiring board 90. The signal input terminals 91 and the power supply terminals 92 are electrically connected to a control unit of the printing apparatus 1000, and are configured to supply ejection drive signals for ejecting the inks and electric power necessary for ejecting the inks, respectively, to the printing element boards 10. The wirings are consolidated by electric circuits in the electric wiring board 90. In this way, the numbers of the signal input terminals 91 and the power supply terminals 92 can be made fewer than the number of the printing element boards 10. For this reason, it is possible to reduce the number of electric connectors to be connected when installing the liquid ejecting head 3 in the printing apparatus 1000 and to be disconnected when replacing the liquid ejecting head 3. Four liquid connectors 111a and four liquid connectors 111b are installed to correspond to the inks of four colors of C, M, Y, and K, respectively, and are connected to liquid supply systems in the printing apparatus 1000 corresponding to the respective ink colors as shown in FIG. 2. Thus, the inks of four colors of C, M, Y, and K are supplied from the supply systems in the printing apparatus 1000 to the liquid ejecting head 3, and the inks having passed through the liquid ejecting head 3 are collected by the supply systems in the printing apparatus 1000. As described above, the inks of the respective colors are circulated through the passages in the printing apparatus 1000 and the passages in the liquid ejecting head 3.

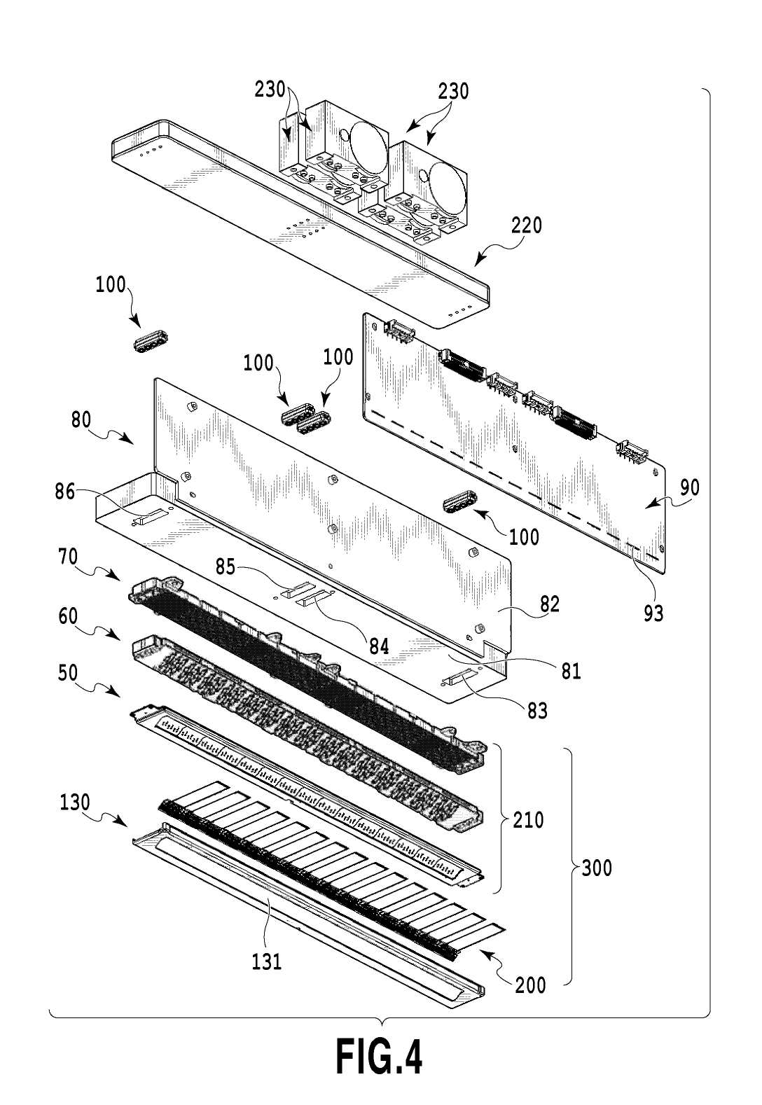

FIG. 4 is an exploded perspective view of the liquid ejecting head 3, in which the liquid ejecting unit 300, the liquid supply unit 220, and the electric wiring board 90 are attached to a housing 80. The liquid supply unit 220 is provided with the liquid connectors 111a and 111b (see FIG. 3B) corresponding to the respective ink colors. Moreover, the filters 221 (see FIG. 2) for the inks of the respective colors communicating with the liquid connectors 111a corresponding to the inks of the respective colors are provided inside the liquid supply unit 220 in order to remove foreign matters in the inks of the respective colors. The inks having passed through the filters 221 are supplied to the negative pressure control units 230 of the respective ink colors. Each negative pressure control unit 230 is a unit including a pressure regulating valve, and is configured to regulate a pressure of the ink by using the valve, a spring member, and the like inside the unit. Specifically, the negative pressure control unit 230 significantly attenuates a change in pressure loss inside the corresponding supply system (the system on the upstream of the liquid ejecting head 3) in the printing apparatus 1000 caused by a change in flow rate of the ink, thus stabilizing the negative pressure on the downstream (the liquid ejecting unit 300 side) of the negative pressure control unit 230 within a certain range. The two pressure regulating mechanisms 230a and 230b are embedded in the negative pressure control unit 230 as shown in FIG. 2. The pressure regulating mechanism 230a on the high pressure side is connected to the common supply passage 211 in the liquid ejecting unit 300 while the pressure generating mechanism 230b on the low pressure side is connected to the common collection passage 212.

The housing 80 includes a liquid ejecting unit support 81 and an electric wiring board support 82 so as to support the liquid ejecting unit 300 and the electric wiring board 90 and to ensure rigidity of the liquid ejecting head 3. The electric wiring board 90 is fixed with screws to the support 82. Openings 83, 84, 85, and 86 to allow insertion of rubber joints 100 are provided in the support 81. Through the rubber joints 100, the inks supplied from the liquid supply unit 220 are introduced to a third passage member 70 that constitutes the liquid ejecting unit 300.

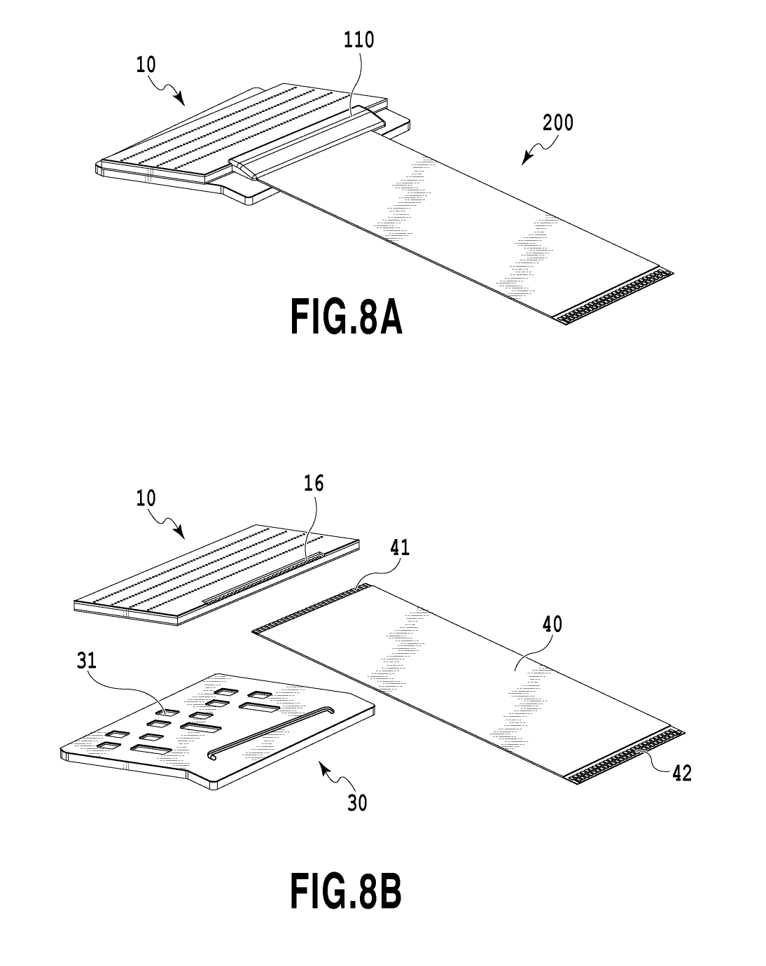

The liquid ejecting unit 300 includes multiple ejecting modules 200 and a passage member 210. A cover member 130 is attached to a surface on the printing medium 2 side of the liquid ejecting unit 300. The cover member 130 is a frame-like member provided with an elongated opening 131 and the printing element boards 10 and sealing members 110 (FIG. 8A) included in the ejecting modules 200 are exposed from the opening 131. The frame portion around the opening 131 functions as a contact surface to come into contact with a cap member that caps the liquid ejecting head 3 during standby for printing. A closed space is preferably defined at the time of the capping by filling irregularities and gaps on an ejecting surface (a surface where ink ejecting ports are formed) of the liquid ejecting unit 300 by coating an adhesive, a sealing material, a filler, and the like along the periphery of the opening 131.

The passage member 210 is formed by stacking a first passage member 50, a second passage member 60, and the third passage member 70. The passage member 210 distributes the inks supplied from the liquid supply unit 220 to the respective ejecting modules 200, and takes the inks returning from the ejecting modules 200 back to the liquid supply unit 220. The passage member 210 is fixed with screws to the liquid ejecting unit support 81.

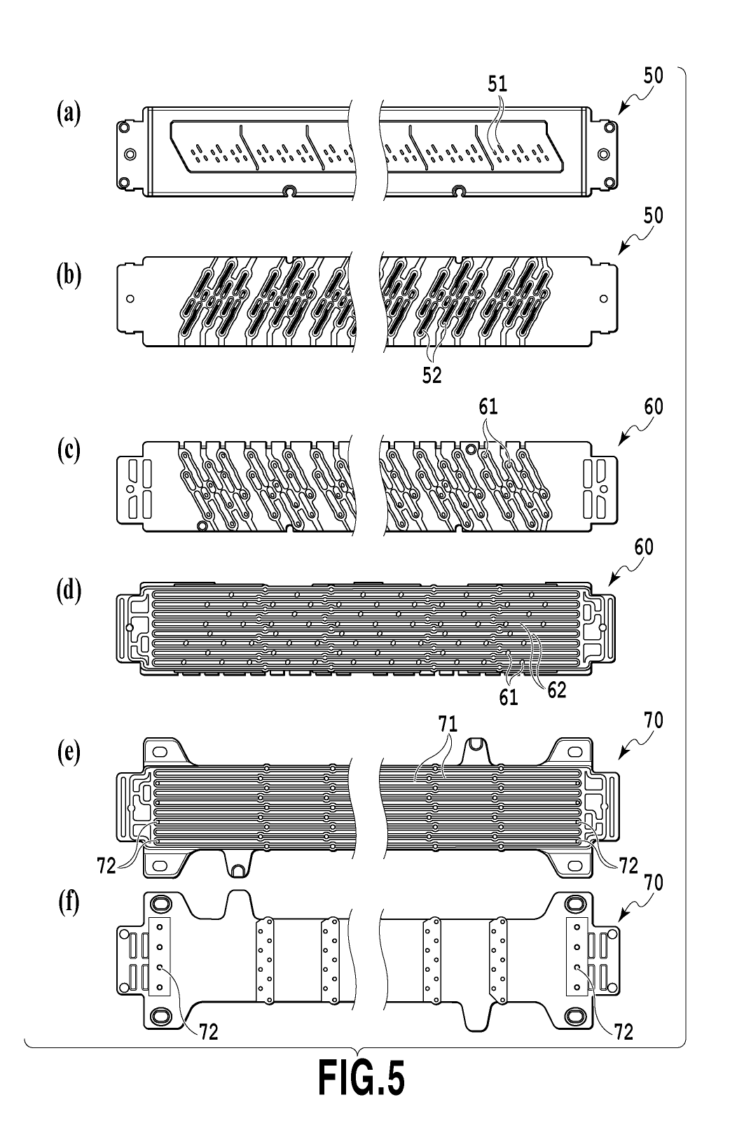

Parts (a) to (f) in FIG. 5 are explanatory diagrams of the first, second, and third passage members. In FIG. 5, part (a) is a diagram of the first passage member 50 viewed from the bottom in FIG. 4 and part (b) is a diagram of the first passage member 50 viewed from the top in FIG. 4. Likewise, in FIG. 5, part (c) is a diagram of the second passage member 60 viewed from the bottom in FIG. 4, part (d) is a diagram of the second passage member 60 viewed from the top in FIG. 4, part (e) is a diagram of the third passage member 70 viewed from the bottom in FIG. 4, and part (f) is a diagram of the third passage member 70 viewed from the top in FIG. 4. The surface of the first passage member 50 in part (b) of FIG. 5 and the surface of the second passage member 60 in part (c) of FIG. 5 are bonding surfaces that come into contact with each other. Meanwhile, the surface of the second passage member 60 in part (d) of FIG. 5 and the surface of the third passage member 70 in part (e) of FIG. 5 are bonding surfaces that come into contact with each other.

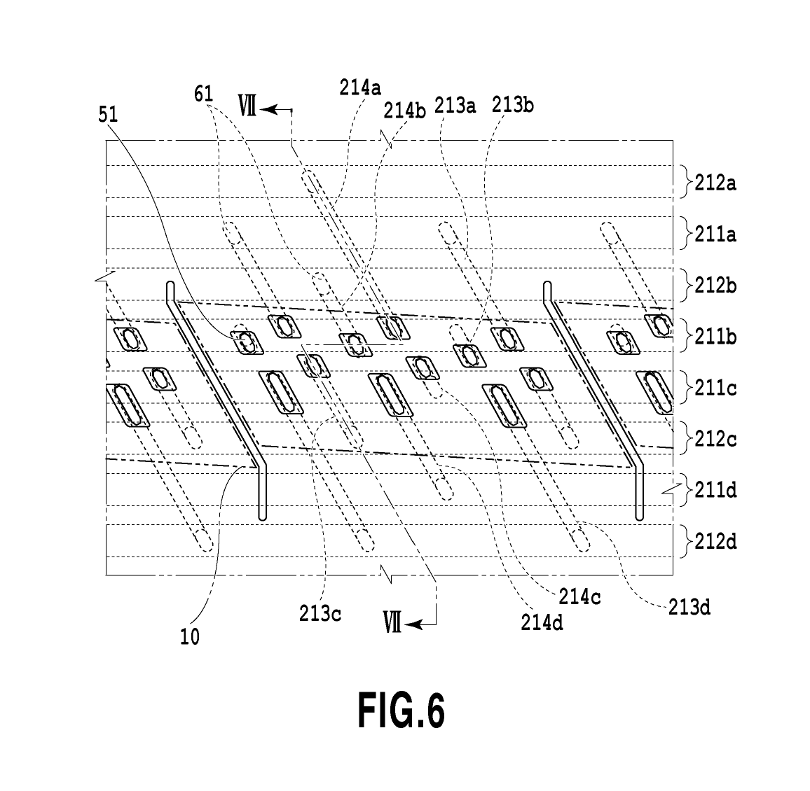

By bonding the second passage member 60 to the third passage member 70, eight common passages extending in a longitudinal direction of the passage members are formed by use of eight common passage grooves 62 in the bonding surface of the former member and common passage grooves 71 in the bonding surface of the latter member. By using these eight common passages, the common supply passages 211 (211a, 211b, 211c, and 211d) and the common collection passages 212 (212a, 212b, 212c, and 212d) for the respective ink colors are formed in the passage member 210 as shown in FIG. 6. Multiple communication ports 72 corresponding to the inflow ports 301a and 301b and the outflow ports 301c for the respective ink colors in the liquid supply unit 220 are formed in the third passage member 70. These communication ports 72 fluidically communicate with the liquid supply unit 220 through the multiple holes in the rubber joints 100. As shown in part (c) of FIG. 5 and FIG. 6, multiple communication ports 61 that communicate with the common passage grooves 62 are formed in the surface of the second passage member 60 on the back of the common passage grooves 62 so as to correspond to the common supply passages 211 and the common collection passages 212 for the respective ink colors. As shown in FIG. 6, each of the communication ports 61 communicates with an end portion of the corresponding one of individual passage grooves 52 formed in the first passage member 50. As shown in FIG. 6, these individual passage grooves 52 form individual supply passages 213 (213a, 213b, 213c, and 213d) and the individual collection passages 214 (214a, 214b, 214c, and 214d) for the respective ink colors. As shown in FIG. 6, communication ports 51, each of which communicates with the other end portion of the corresponding one of the individual passage grooves 52, are formed in the first passage member 50. These communication ports 51 fluidically communicate with the multiple ejecting modules 200. The passages of the inks can be consolidated into a center side of the passage member by using the individual passage grooves 52.

A material for forming each of the first, second, and third passage members preferably has corrosion resistance against the inks and is of a quality with a low linear expansion coefficient. Examples of suitable materials include alumina and a resin material. As for the resin material, a liquid crystal polymer (LCP) or polyphenyl sulfide (PPS) is preferable. Meanwhile, another example of the suitably usable material is a composite material (a resin material) formed by adding an inorganic filler such as fine particles of silica or fibers to polysulfone (PSF) or modified polyphenylene ether (PPE) serving as a matrix.

FIG. 6 is an enlarged diagram of a substantial part of passages in the passage member 210 formed by bonding the first to third passage members, seen through from the bottom side of the first passage member 50 in FIG. 4 (from the surface on which the ejecting module 200 are mounted). As mentioned previously, the common supply passages 211 (211a, 211b, 211c, and 211d) and the common collection passages 212 (212a, 212b, 212c, and 212d), which extend in the longitudinal direction of the liquid ejecting head 3, are formed in the passage member 210 so as to correspond to the respective ink colors. The multiple individual supply passages 213 (213a, 213b, 213c, and 213d) formed of the individual passage grooves 52 are connected to the common supply passages 211 for the respective ink colors through communication ports 61. Meanwhile, the multiple individual collection passages 214 (214a, 214b, 214c, and 214d) formed of the individual passage grooves 52 are connected to the common collection passages 212 for the respective ink colors through the communication ports 61. The above-described passage configuration enables the passage member to supply the inks in a consolidated manner from the common supply passages 211 to the printing element boards 10 located at the center in a vertical direction in FIG. 6 through the individual supply passages 213. Moreover, it is possible to take the inks from the printing element boards 10 back to the common collection passages 212 through the individual collection passages 214.

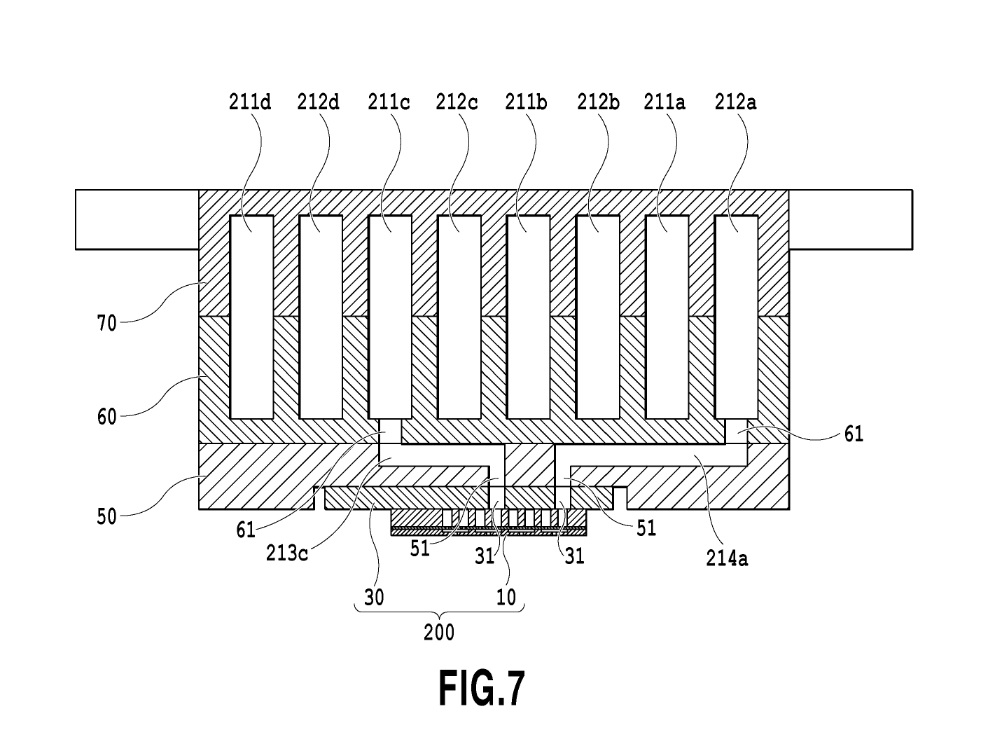

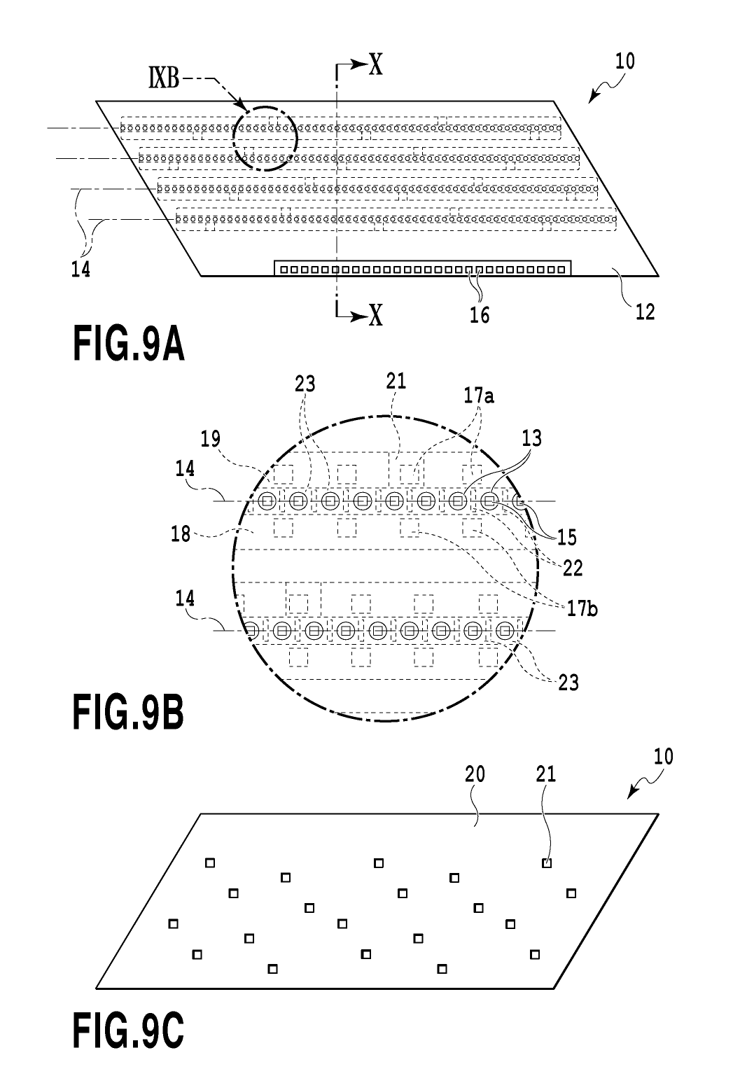

FIG. 7 is a cross-sectional view taken along the VII-VII line in FIG. 6. The individual supply passage 213c and the individual collection passage 214a communicate with the ejecting module 200 through communication ports 51. Likewise, on another cross section, a different individual supply passage and a different individual collection passage communicate with the ejecting submodule 200. Passages for the ink are formed in a support member 30 and in the printing element board 10 which are included in each ejecting module 200. The passages include a passage for supplying the ink from the first passage member 50 to a pressure chamber of the printing element board 10 where a printing element 15 (see FIG. 9B) is located, and a passage for taking (collecting) part or all of the ink supplied to the pressure chamber back to the first passage member 50. As described previously, the common supply passage 211 for each ink color is connected to the pressure regulating mechanism 230a on the high pressure side in the corresponding negative pressure control unit 230 through the liquid supply unit 220. Meanwhile, the common collection passage 212 for each ink color is connected to the pressure regulating mechanism 230b on the low pressure side in the corresponding negative pressure control unit 230 through the liquid supply unit 220. The ink is circulated as described above by the difference in pressure between the common supply passage 211 and the common collection passage 212 and by the first circulation pump 1002 connected solely to the common collection passage 212. In other words, the ink of each color flows sequentially through the common supply passage 211, the individual supply passage 213, the printing element board 10, the individual collection passage 214, and the common collection passage 212.

### (Ejecting Module)

FIG. 8A is a perspective view of one of the ejecting modules 200 and FIG. 8B is an exploded view thereof. In manufacturing of each ejecting module 200, the printing element board 10 and the flexible wiring substrate 40 are first bonded onto the support member 30 provided with communication ports 31 in advance. Thereafter, a terminal 16 on the printing element board 10 is connected to a terminal 41 on the flexible wiring substrate 40 by wire bonding, and then the wire bonded part (an electrically connected part) is covered and sealed with a sealing material 110. A terminal 42 of the flexible wiring substrate 40 located at the opposite side from the printing element board 10 is electrically connected to a connection terminal 93 (see FIG. 4) of the electric wiring board 90. The support member 30 is a support for the printing element board and is also a passage member to establish fluidical communication between the printing element board 10 and the passage member 210. For this reason, the support member 30 is preferably a member having a high degree of flatness and being the one that can be bonded to the printing element board 10 with sufficiently high reliability. Examples of suitable materials therefor include alumina and a resin material.

### (Printing Element Board)

FIG. 9A is a plan view of the printing element board 10 observed from an ejecting port 13 side, FIG. 9B is an enlarged view of a circular portion IXb in FIG. 9A, and FIG. 9C is a plan view of the printing element board 10 observed from the opposite side from the ejecting ports 13. As shown in FIG. 9A, four ejecting port arrays 14 corresponding to the respective ink colors are formed in an ejecting port forming member 12 of the printing element board 10. An extending direction of the ejecting port arrays 14 in which the multiple ejecting ports 13 are arranged will be hereinafter referred to as an “ejecting port array direction” as appropriate.

As shown in FIG. 9B, an ejecting energy generating element to generate energy for ejecting the ink is provided as the printing element 15 at a position corresponding to each ejecting port 13. The printing element 15 in this embodiment is a heating element (a thermoelectric conversion element) for creating a bubble in the ink by using heat energy. Pressure chambers 23 each including the corresponding printing element 15 are defined by use of partition walls 22. Each printing element 15 is electrically connected to the terminal 16 in FIG. 9A by electric wiring (not shown) provided on the printing element board 10. The printing element 15 brings the ink to a boil by generating the heat based on a pulse signal inputted from a control circuit of the printing apparatus 1000. The ink is ejected from the ejecting port 13 by bubbling energy generated by the boil. As shown in FIG. 9B, liquid supply passages 18 and liquid collection passages 19 are formed in the printing element board 10 in such a way as to extend along the respective ejecting port arrays 14. Each liquid supply passage 18 is located on one side of the corresponding ejecting port array 14, and communicates with the ejecting ports 13 through supply ports 17a. Each liquid collection passage 19 is located on the other side of the corresponding ejecting port array 14, and communicates with the ejecting ports 13 through collection ports 17b.

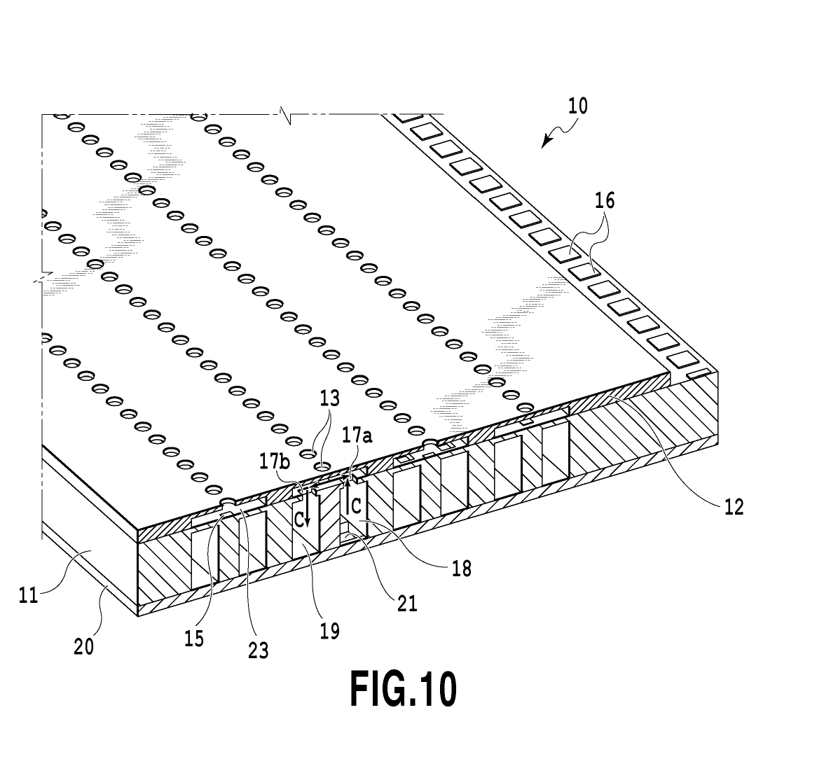

As shown in FIGS. 9C and 10, a sheet-like lid member 20 is stacked on a surface of the printing element board 10 located on the opposite side from the ejecting port forming member 12. The lid member 20 is provided with multiple openings 21 that communicate with the liquid supply passages 18 and the liquid collection passages 19. In this embodiment, each liquid supply passage 18 is provided with two openings 21 while each liquid collection passage 19 is provided with one opening 21. These openings 21 of the lid member 20 communicate with the communication ports 51 of the first passage member 50 as in part (a) of FIG. 5. The lid member 20 has a function as a lid which constitutes part of walls of the liquid supply passages 18 and the liquid collection passages 19 formed in a substrate 11 of the printing element board 10 as shown in FIG. 10. The lid member 20 preferably has sufficient corrosion resistance against the inks. Moreover, opening shapes and opening positions of the openings 21 are required to satisfy high accuracy from the viewpoint of preventing color mixture of the inks. For this reason, it is preferable to use a photosensitive resin material or a silicon plate as a material of the lid member 20, and to provide the openings 21 by a photolithographic process. As mentioned above, the lid member is configured to change pitches of the passages by use of the openings 21. The lid member preferably has a small thickness in consideration of the pressure loss, and is preferably formed from a film-like member.

FIG. 10 is a perspective view of the printing element board 10 and the lid member 20, which are sectioned along the X-X line in FIG. 9A. In the printing element board 10, the substrate 11 made of Si and the ejecting port forming member 12 made of a photosensitive resin are stacked on each other, and the lid member 20 are bonded to a back surface of the substrate 11. The printing elements 15 are formed on one surface of the substrate 11 (see FIG. 9B), while grooves constituting the liquid supply passages 18 and the liquid collection passages 19 extending along the ejecting port arrays 14 are formed in the other surface of the substrate 11. The liquid supply passages 18 and the liquid collection passages 19 formed by the substrate 11 and the lid member 20 are connected to the common supply passage 211 and the common collection passage 212 in the passage member 210, respectively. As a consequence, the difference in pressure occurs between each liquid supply passage 18 and the corresponding liquid collection passage 19. When an image is printed by ejecting the inks from the multiple ejecting ports 13 of the liquid ejecting head 3, the ink flows in each ejecting port, which does not eject the ink, by using the difference in pressure between the liquid supply passage 18 and the liquid collection passage 19. In other words, the ink in the liquid supply passage 18 in the substrate 11 flows to the liquid collection passage 19 through the supply port 17a, the pressure chamber 23, and the collection port 17b as indicated with arrows C in FIG. 10. This flow makes it possible to take a thickened ink caused by evaporation from the ejecting port 13 as well as foreign matters such as bubbles, which reside in the ejecting port 13 and the pressure chamber 23 suspending the ink ejection, back to the liquid collection passage 19. Moreover, it is also possible to suppress thickening of the ink in the ejecting port 13 and the pressure chamber 23. The ink taken back to the liquid collection passage 19 is taken back from the opening 21 of the lid member 20 and the liquid communication port 31 (see FIG. 8B) of the support member 30 through the communication port 51, the individual collection passage 214, and the common collection passage 212 in the passage member 210. The ink is eventually taken back to the supply passage of the printing apparatus 1000.

In short, the ink supplied from the body of the printing apparatus to the liquid ejecting head 3 is supplied and collected while being circulated in the following order. Specifically, the ink first flows into the liquid ejecting head 3 from the liquid connector 111a of the liquid supply unit 220. The ink is then supplied sequentially in the order of the hole of the rubber joint 100, the communication port 72 and the common passage groove 71 of the third passage member 70, the common passage groove 62 and the communication port 61 of the second passage member 60, and the individual passage groove 52 and the communication port 51 of the first passage member 50. Thereafter, the ink is sequentially passed through the liquid communication port 31 of the support member 30, the opening 21 of the lid member 20, and the liquid supply passage 18 and the supply port 17a of the substrate 11, and is supplied to the pressure chamber 23. Of the ink supplied to the pressure chamber 23, a portion of the ink not ejected from the ejecting port 13 flows sequentially through the collection port 17b and the liquid collection passage 19 of the substrate 11, the opening 21 of the lid member 20, and the liquid communication port 31 of the support member 30. Moreover, the ink flows through the communication port 51 and the individual passage groove 52 of the first passage member 50, the communication port 61 and the common passage groove 62 of the second passage member 60, the common passage groove 71 and the communication port 72 of the third passage member 70, and the hole of the rubber joint 100. Furthermore, the ink flows out of the liquid ejecting head 3 through the liquid connector 111b of the liquid supply unit 220. In the ink circulation passage in FIG. 2, the ink flowing into the liquid connector 111a is passed through the negative pressure control unit 230, and is then supplied through the hole of the rubber joint 100.

As described above, the liquid ejecting head of this embodiment can print a high-quality image while suppressing occurrence of misdirection in terms of the ink ejecting direction as well as ejection failures, which are attributed to the thickened ink in the pressure chamber and in the vicinity of the ejecting port.

### (Positional Relation Between Printing Element Boards)

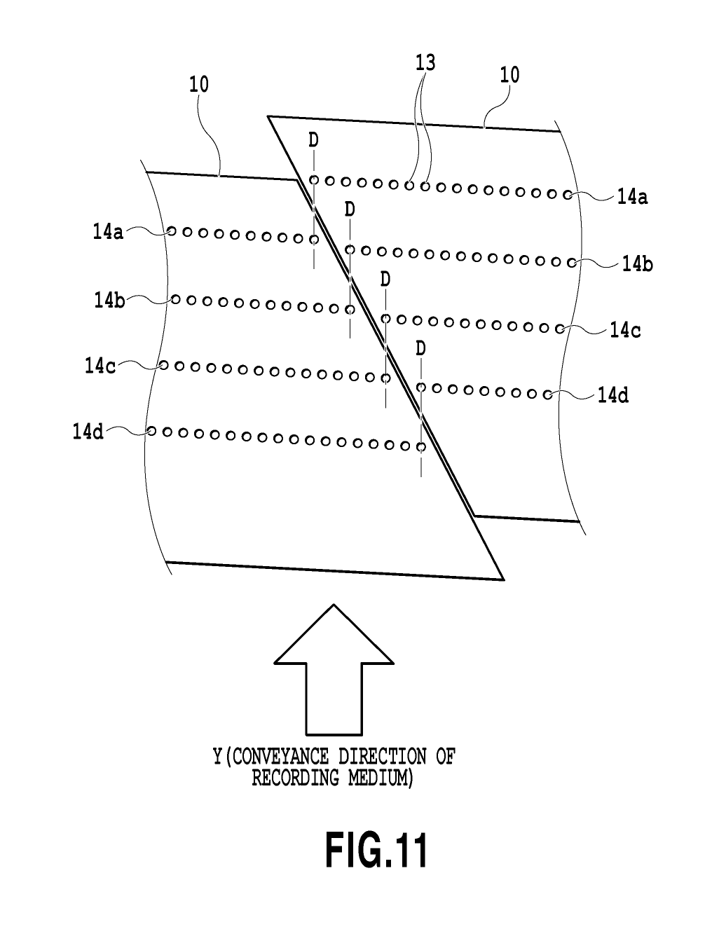

FIG. 11 is an enlarged plan view of abutting portions of one printing element board 10 and another printing element board 10 that belong, respectively, to two ejecting modules 200 abutting on each other. As shown in FIG. 9A, the printing element boards 10, each of which has a plane substantially in the form of a parallelogram, are used in this embodiment. As shown in FIG. 11, the ejecting port arrays 14 (14a, 14b, 14c, and 14d) in each printing element board 10 including the arranged ejecting ports 13 are laid out in such a way as to be inclined by a prescribed angle with respect to the conveyance direction of the printing medium 2 (the direction of the arrow Y). In this way, regarding the ejecting port arrays 14 at the abutting portions of a pair of the printing element boards 10, at least one ejecting port 13 of one of the ejecting port arrays 14 overlaps one ejecting port 13 of the other ejecting port array 14 in the conveyance direction of the printing medium 2. In FIG. 11, two ejecting ports 13 on a line D along the conveyance direction overlap each other. According to the above-described layout of the ejecting port arrays 14, even if the positions to install the printing element boards 10 are slightly misaligned with respect to prescribed positions, it is possible to obscure streaks, voids, and the like on a printed image by controlling the drive of the ejecting ports 13 that overlap one another. The configuration as shown in FIG. 11 is also applicable to a case where the multiple printing element boards 10 are arranged in alignment (disposed in line) instead of a staggered arrangement. Thus, it is possible to obscure streaks, voids, and the like on a printed image corresponding to a junction of the printing element boards 10 while suppressing the length of the liquid ejecting head 3 in the conveyance direction of the printing medium 2. Note that the planar shape of each printing element board is not limited only to the parallelogram as described in this embodiment, and the printing element board may have a rectangular shape, a trapezoidal shape, and any other shapes, for example.

### (In-Mold Bonding)

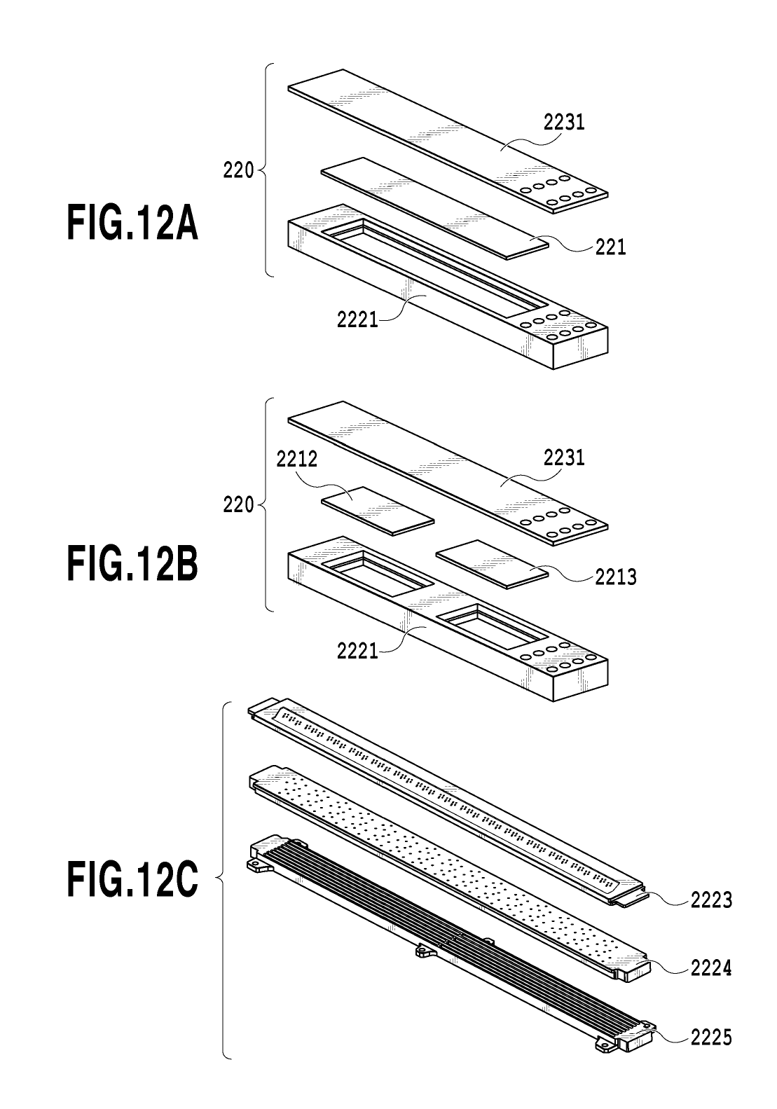

As shown in FIG. 12A, the liquid supply unit 220 includes a passage forming member 2221, a passage lid member 2231, and the filter 221. A liquid supply passage for supplying the ink to the liquid ejecting unit is formed in the passage forming member 2221, while the passage lid member 2231 is bonded to the passage forming member 2221 to prevent a leakage of the ink. The filter 221 removes foreign matters and bubbles in the ink that flows in the liquid supply passage. The passage forming member 2221 is preferably formed by injection molding of a resin from the viewpoint of mass productivity.

Particularly, in the case of the line-type liquid ejecting head as in this embodiment, component parts are increased in size as compared to those for a serial-type liquid ejecting head. For this reason, in the course of producing the passage forming member 2221 by injection molding, torsion or warpage may occur in the passage forming member 2221 due to cure shrinkage of the resin when the passage forming member 2221 is detached from the mold after the injection molding, and the shape of the passage forming member 2221 may be changed as a consequence. In case of a significant change in shape of the passage forming member 2221, the passage forming member 2221 may not be appropriately bonded to the components such as the filter 221. Specifically, the change in shape of the passage forming member 2221 attributed to the cure shrinkage after the demolding may reduce the degree of flatness of a bonding surface of the passage forming member 2221 to the filter 221, and there is a risk of failure to bond the filter 221 to part of the bonding surface. In this case, the filter 221 cannot fulfill the function to remove foreign matters and bubbles. Meanwhile, when the passage lid member 2231 produced by injection molding is bonded to the passage forming member 2221, a bonding surface of the passage lid member 2231 may also be deformed by cure shrinkage. In this case, two bonding surfaces having the low degree of flatness have to be bonded to each other, so that it is difficult to establish appropriate bonding in all of the bonding surfaces. In other words, there is a risk of damaging the function of the passage lid member 2231 due to a failure to closely attach the bonding surfaces of two bonding components so as not to cause a leakage of the ink.

In order to appropriately bond the above-described two bonding components, it is necessary to correct the change in shape of the passage forming member 2221 and to enhance the degree of flatness thereof. To this end, it is preferable to reduce the effect of the change in shape of the passage forming member 2221 and to bond the filter 221 and the passage lid member 2231 to the passage forming member 2221 in this state. Moreover, it is also preferable to hold a portion right below the bonding surfaces thereof by using a jig so as to transmit a force to be applied at the time of bonding efficiently to the bonding surfaces.

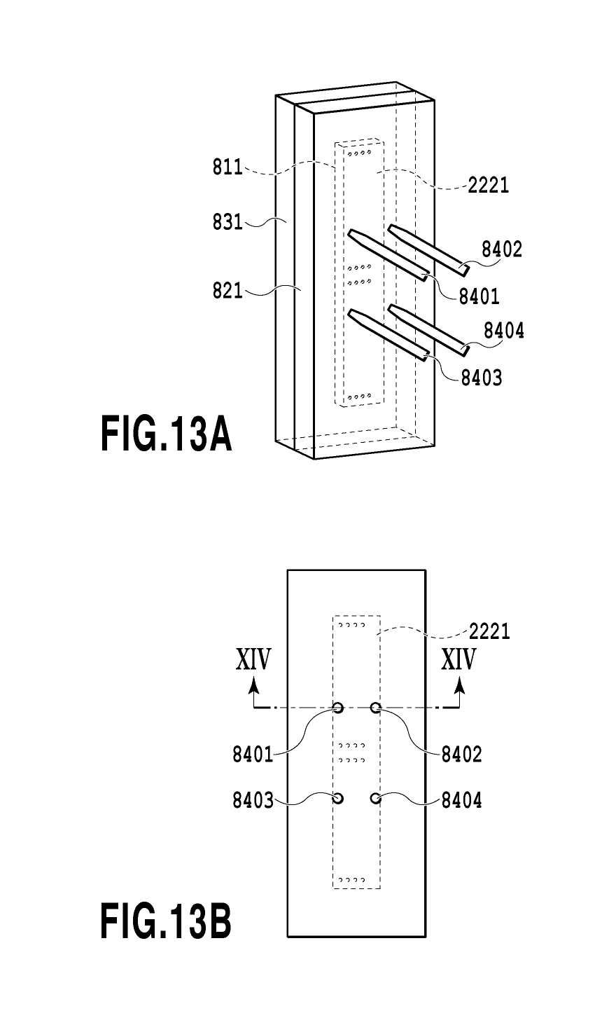

Accordingly, in this embodiment, injection molds as shown in FIGS. 13A and 13B are used in order to block the effect of the change in shape of the passage forming member 2221.

As shown in FIG. 13A, the injection mold of this embodiment includes a fixed mold 821 provided with a molding space 811, and a movable mold 831, which are made movable relative to each other. The passage forming member 2221 as a molded product is injection molded inside the injection mold that are openable and closable as described above. Meanwhile, reference numerals 8401, 8402, 8403, and 8404 in FIG. 13A denote valve gates used for injecting the resin. FIG. 13B is a plan view of the injection mold of this embodiment.

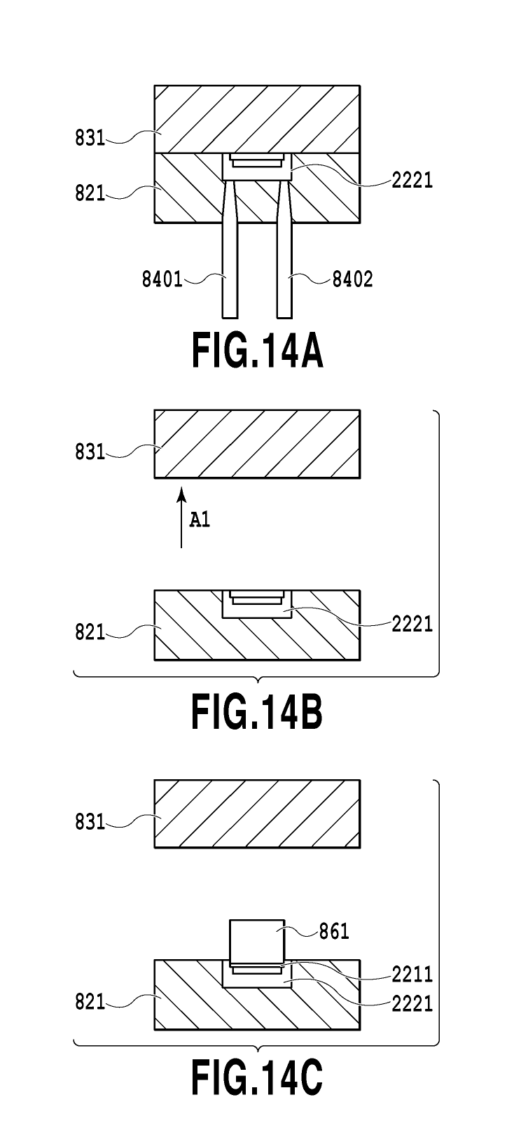

FIGS. 14A, 14B, and 14C are cross-sectional views for explaining steps of bonding and fixing the passage forming member 2221, which is a component part of the liquid supply unit 220 of the liquid ejecting head 3, to other components when producing the liquid supply unit 220. These cross-sectional views are cross-sectional views taken along the XIV-XIV line in FIG. 13B.

FIG. 14A shows a first step of clamping the fixed mold 821 and the movable mold 831 together, and then injection molding the passage forming member 2221 by filling the molding space 811 with a molding resin. The molding resin is injected from the valve gates. In a subsequent second step, the movable mold 831 is opened in a direction of an arrow A1 as shown in FIG. 14B. The injection molded passage forming member 2221 is held by the fixed mold 821 while the movable mold 831 is moved in the direction of the arrow A1. Thus, the fixed mold 821 can suppress the change in shape of the passage forming member 2221 such as torsion or warpage attributed to the cure shrinkage. In a subsequent third step, as shown in FIG. 14C, a filter 2211 is bonded to the passage forming member 2221 using a bonding jig 861 while leaving the passage forming member 2221 on the fixed mold 821. By leaving the passage forming member 2221 on the fixed mold 821 as described above, a portion immediately below the bonding surfaces of the filter 2211 and the passage forming member 2221 is held by the fixed mold 821 with no gap in between. Accordingly, it is possible to efficiently transmit the force to be applied at the time of bonding to the bonding surfaces, and thus to appropriately bond the bonding surfaces to each other.

Moreover, it is preferable to press a bonding target component to be bonded to the passage forming member 2221 against the bonding surface of the passage forming member 2221, and thus to correct the change in shape of the passage forming member 2221 attributed to the cure shrinkage. Furthermore, it is preferable to press the bonding target component against the bonding surface of the passage forming member 2221 by using a highly rigid jig or the like in order to enhance the correcting effect. Examples of the bonding target component include the filter 2211 for removing foreign matters and bubbles included in the ink flowing in the liquid supply passage, the passage lid member 2231 to cap the liquid supply passage so as not to cause the leakage of the ink, a second passage forming member provided with a passage, and the like. The bonding target component is preferably a component that can impart a function to the liquid supply unit 220. Moreover, a passage to be formed by bonding any of the aforementioned components preferably has low passage resistance. Furthermore, any of a large-area filter, a second passage forming member that enable setting of a large passage cross-sectional area, and a passage lid member that enable setting of a large passage cross-sectional area are preferable as the bonding target component.

In the meantime, there may be two or more components to be bonded to the passage forming member 2221. For example, as shown in FIG. 12B, the liquid supply unit 220 adaptable to the inks of multiple colors can be formed so as to constitute passages in which multiple filters 2212, 2213 and multiple passages are arranged in parallel. Alternatively, the liquid supply unit 220 may be configured to include a passage forming member that constitutes part of the above-described liquid ejecting unit 300. For example, the liquid supply unit 220 may be configured such that passage forming members 2223, 2224, and 2225 are bonded to one another as shown in FIG. 12C. In this case, the passage forming member 2223 to be left on the fixed mold 821 and the passage forming member 2224 to be bonded to the passage forming member 2223 are bonded to each other. A bonding surface of the passage forming member 2224 may be larger than a bonding surface of the passage forming member 2223 side, or these bonding surfaces may have substantially the same area.

In order to bond the filter 221 to the passage forming member 2221, it is preferable to apply any of thermal welding, ultrasonic welding, vibration welding, and the like so that the filter 221 can be impregnated with the molten resin of the passage forming member 2221 to establish fixation and to enhance bonding strength therebetween. Meanwhile, in order to bond the resin molded component such as the second passage forming member to the passage forming member 2221, it is preferable to apply any of ultrasonic welding, vibration welding, laser beam welding, and the like while taking advantage of an ability of the fixed mold 821 to receive a portion right below a bonded portion of the passage forming member 2221 with no gap.

According to the above-described steps, it is possible to manufacture the liquid supply unit at high accuracy since the various components are bonded to the passage forming member while suppressing the effect of the change in shape of the passage forming member. Moreover, by joining the above-described liquid supply unit to a printing head, it is possible to produce the liquid ejecting head of the line type that achieves high image quality.

### Second Embodiment

As with the first embodiment, the liquid supply unit 220 of this embodiment includes the passage forming member 2221, the passage lid member 2231, and the filter 221. In this embodiment, the two molded components, namely, the passage forming member 2221 and the passage lid member 2231, are bonded to the components such as the filter 221 inside a single mold. The components to be bonded to the passage forming member 2221 is not limited only to the passage lid member 2231. The component to be bonded may be any of components having various other functions, such as a second passage member 2222 provided with the passage.

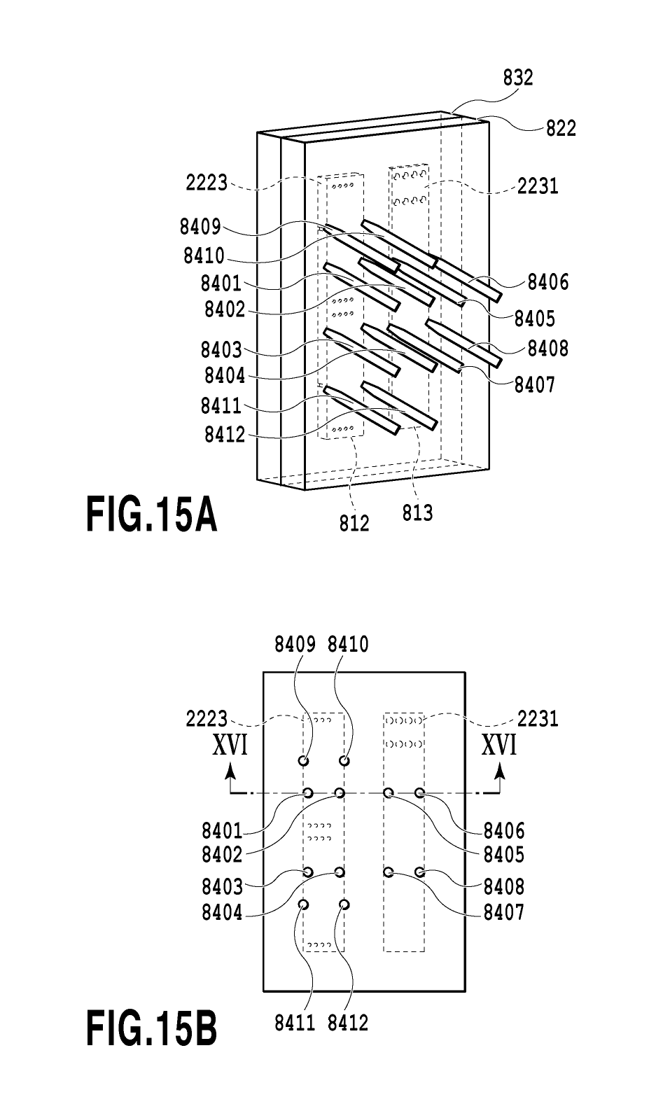

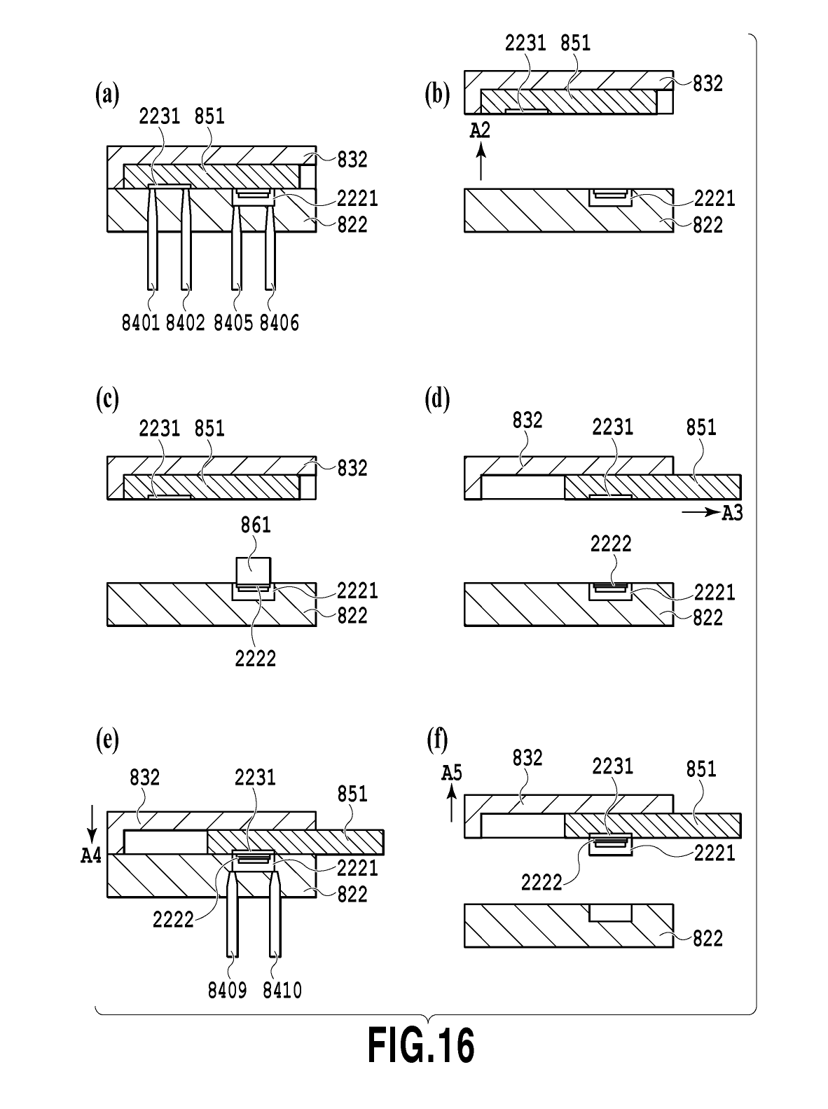

FIG. 15A is a perspective view of a mold for injection molding in the second embodiment of the present invention. FIG. 15B is a plan view of the mold. The mold of this embodiment is formed from a fixed mold 822 including molding spaces 812 and 813, and a movable mold 832. A die slide mechanism 851 (see part (d) of FIG. 16) is disposed in the movable mold 832. The first molding space 812 for molding the passage forming member 2221, and the second molding space 813 for molding the passage lid member 2231 are provided inside the mold. Valve gates 8401 to 8404 inject a resin for molding the passage forming member 2221, while valve gates 8405 to 8408 inject a resin for forming the passage lid member 2231. Meanwhile, valve gates 8409 to 8412 inject a resin for bonding the passage forming member 2221 to the passage lid member 2231.

Parts (a) to (f) in FIG. 16 are cross-sectional views for explaining steps of bonding and fixing the passage forming member 2221, which is a component part of the liquid supply unit 220, to other components when producing the liquid supply unit 220. These cross-sectional views are cross-sectional views taken along the XVI-XVI line in FIG. 15B.

In a first step to begin with, as shown in part (a) of FIG. 16, the fixed mold 822 and the movable mold 832 are clamped together. Then, the passage forming member 2221 is injection molded in the first molding space 812 and the passage lid member 2231 is injection molded in the second molding space 813. The resins for molding the passage forming member 2221 and the passage lid member 2231 are injected from the valve gates 8401 to 8408 formed at the respective molding spaces. In a subsequent second step, as shown in part (b) of FIG. 16, the movable mold 832 is moved in a direction of an arrow A2 to open the mold. The passage lid member 2231 molded in the second molding space 813 remains held by the movable mold 832 and is moved together with the movable mold 832. Meanwhile, the passage forming member 2221 molded in the first molding space 812 remains held by the fixed mold 822 and is not moved. As described above, the injection molded passage lid member 2231 is held by the movable mold 832 while the injection molded passage forming member 2223 is held by the fixed mold 822. Accordingly, it is possible to suppress the changes in shape of the passage lid member 2231 and the passage forming member 2223 such as torsion or warpage attributed to the cure shrinkage.

In a subsequent third step, as shown in part (c) of FIG. 16, a second passage forming member 2222 (inclusive of the filter 221 and the like) is bonded by using the bonding jig 861 while leaving the passage forming member 2221 on the fixed mold 822. At this time, by leaving the passage forming member 2221 on the fixed mold 822, the fixed mold 822 holds a portion right below the bonding surface of the passage forming member 2221 with no gap. Thus, it is possible to transmit a force to be applied at the time of bonding efficiently to the bonding surface, thereby establishing appropriate bonding. Moreover, it is preferable to press a bonding target component such as the passage forming member 2222 against the bonding surface of the passage forming member 2221, and thus to correct the change in shape of the passage forming member 2221 attributed to the cure shrinkage. Furthermore, it is preferable to press the bonding target component against the bonding surface of the passage forming member 2221 by using a highly rigid jig or the like in order to enhance the correcting effect.

Examples of the bonding target component include the filter 221 for removing foreign matters and bubbles included in the liquid flowing in the liquid supply passage, the second passage forming member 2222 provided with the passage, the passage lid member 2231 to cap the liquid supply passage so as not to cause the leakage of the ink, and the like. Components having various functions can be bonded to the passage forming member 2221. Moreover, a passage to be formed by bonding the aforementioned components preferably has low passage resistance. Furthermore, any of a large-area filter, and a set including the second passage forming member and the passage lid member that enable setting of a large passage cross-sectional area is preferable as the bonding target component. In the meantime, there may be two or more components to be bonded to the passage forming member 2221. The liquid supply unit 220 adaptable to the inks of multiple colors can be manufactured such that multiple filters 221 as well as multiple passages collectively constitute passages that are arranged in parallel.

Meanwhile, in order to bond the filter 221, it is preferable to apply any of thermal welding, ultrasonic welding, vibration welding, and the like so that the filter 221 can be impregnated with the molten resin of the passage forming member 2221 to establish the fixation and to enhance bonding strength therebetween. In the meantime, in order to bond a resin molded component such as the second passage forming member 2222 to the passage forming member 2221, it is preferable to apply any of ultrasonic welding, vibration welding, laser beam welding, and the like while taking advantage of the ability of the fixed mold 821 to receive the portion right below the bonded portion of the passage forming member 2221 with no gap.

Thereafter, as shown in part (d) of FIG. 16, the movable mold 832 is moved in a direction of an arrow A3 while holding the passage lid member 2231, such that the passage lid member 2231 and the passage forming member 2221 held by the fixed mold 822 are opposed to each other. To achieve the above-mentioned movement, the movable mold 832 includes the die slide mechanism 851 which is slidable along the arrow A3. Hence, the movable mold 832 is moved by the die slide mechanism 851 without causing movement of an outer edge of the movable mold 832. The above-described movement of the movable mold 832 may take place before bonding the component such as the passage forming member 2222 (inclusive of the filter 221 and the like) as shown in part (c) of FIG. 16, as long as the movement takes place after opening the mold as shown in part (b) of FIG. 16.

Next, as shown in part (e) of FIG. 16, the mold is closed by moving the movable mold 832 in a direction of an arrow A4 toward the fixed mold 822. At this time, a bonded portion of the passage lid member 2231 held by the movable mold 832 comes into contact with the bonded portion of the passage forming member 2221 held by the fixed mold 822. Thereafter, contact portions of the passage forming member 2221 and of the passage lid member 2231 are bonded to each other. In order to achieve the bonding, a resin material is injected from the valve gates 8409 to 8412 to the contact portions of the passage forming member 2221 and of the passage lid member 2231. Since the above-described bonding can be carried out in the course of the series of the steps, it is possible to shorten cycle time when manufacturing the liquid supply unit 220. Moreover, since the injection molded passage forming member 2221 is held by the fixed mold 822 and the injection molded passage lid member 2231 is held by the movable mold 832, it is possible to suppress the changes in shape of these members 2221 and 2231 such as torsion or warpage attributed to the cure shrinkage.

A bonding material (a resin material) to be filled into the contact portions of the molded components of the bonding targets in order to bond the components to each other preferably has a linear expansion coefficient that is about the same as that of the molding material of the bonding targets so as to enhance bonding strength. Meanwhile, a filling pressure at the time of filling the contact portions with the bonding material is applied to the contact portions. In order to maintain an appropriate state of contact between the molded components of the bonding targets regardless of the filling pressure, it is preferable to apply the filling pressure evenly to the passage forming member 2221 and to the passage lid member 2231.

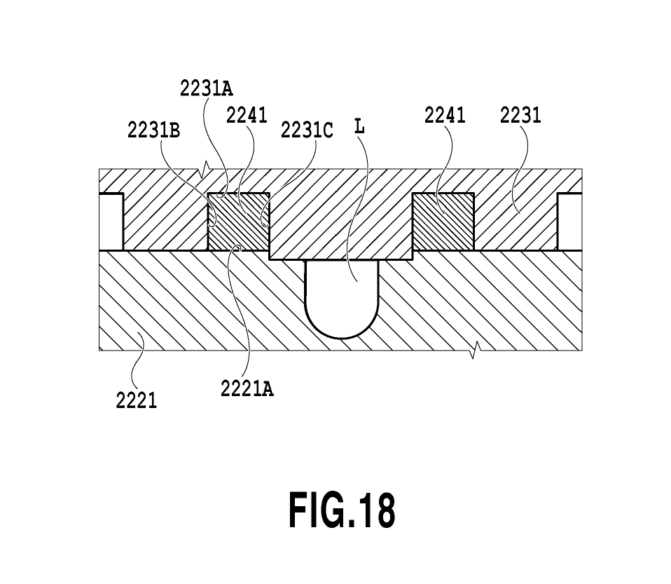

For example, a case where the passage forming member 2221 and the passage lid member 2231 collectively constituting a passage L are bonded to each other by filling spaces between the passage forming member 2221 and the passage lid member 2231 with a bonding material (a resin material) 2441 is assumed as shown in FIG. 18. In this case, a bonding surface 2221A of the passage forming member 2221 comes into contact with the bonding material 2241, and bonding surfaces 2231A, 2231B, and 2231C of the passage lid member 2231 come into contact with the bonding material 2241. A projected area when projecting the bonding surface 2221A onto the passage lid member 2231 corresponds to the area of the bonding surface 2221A. Meanwhile, a projected area when projecting each of the bonding surfaces 2231A, 2231B, and 2231C onto the passage forming member 2221 corresponds to the area of the bonding surface 2231A. The bonding surfaces of the passage forming member 2221 and the passage lid member 2231 are set such that these projected areas are substantially equal to one another. Thus, it is possible to apply the filling pressure of the bonding material 2241 evenly to the passage forming member 2221 and the passage lid member 2231 in the bonding direction thereof. Consequently, it is possible to suppress deformations of the passage forming member 2221 and the passage lid member 2231, and to prevent an adverse effect such as a leakage of the bonding material to be filled in order to seal the space therebetween. As a result, it is possible to appropriately bond the passage forming member 2221 to the passage lid member 2231, and to securely seal the space therebetween. In this way, the bonding material 2241 also functions as a sealing material.

Incidentally, the resin material to be filled in the space between the contact portions of the bonding target components only needs to be a material which is compatible with the molding materials of the bonding target components. An effect similar to the one described above is also obtained even in the case of using a material different from the molding materials of the bonding target components. Meanwhile, if a region to be filled with the resin material either has a large area or an intricate shape, then it is preferable to fill the region with a resin material having high fluidity as well as compatibility with the molding materials of the bonding target components.

Lastly, as shown in part (f) of FIG. 16, the mold is opened by moving the movable mold 832 in a direction of an arrow A5. Thus, the liquid supply unit 220 formed of the three members 2221, 2222, and 2231 is taken out. In this embodiment, a plane on which the bonding surfaces of the passage forming member 2221 and the second passage forming member 2222 (inclusive of the filter and the like) are located is different from a plane on which the bonding surfaces of the passage forming member 2221 and the passage lid member 2231 are located.

As with the above-described embodiment, the liquid supply unit 220 adaptable to the inks of multiple colors can also be manufactured in this embodiment such that the multiple filters 2212 and 2213 as well as the multiple passages collectively constitute passages that are arranged in parallel as shown in FIG. 12B. Alternatively, the liquid supply unit 220 may include a passage forming member that constitutes part of the above-described liquid ejecting unit 300. For example, the liquid supply unit 220 may be configured such that the passage forming members 2223, 2224, and 2225 are bonded to one another as shown in FIG. 12C. In this case, the passage forming member 2223 to be left on the fixed mold 821 and the passage forming member 2224 to be bonded to the passage forming member 2223 are bonded to each other.

### Third Embodiment

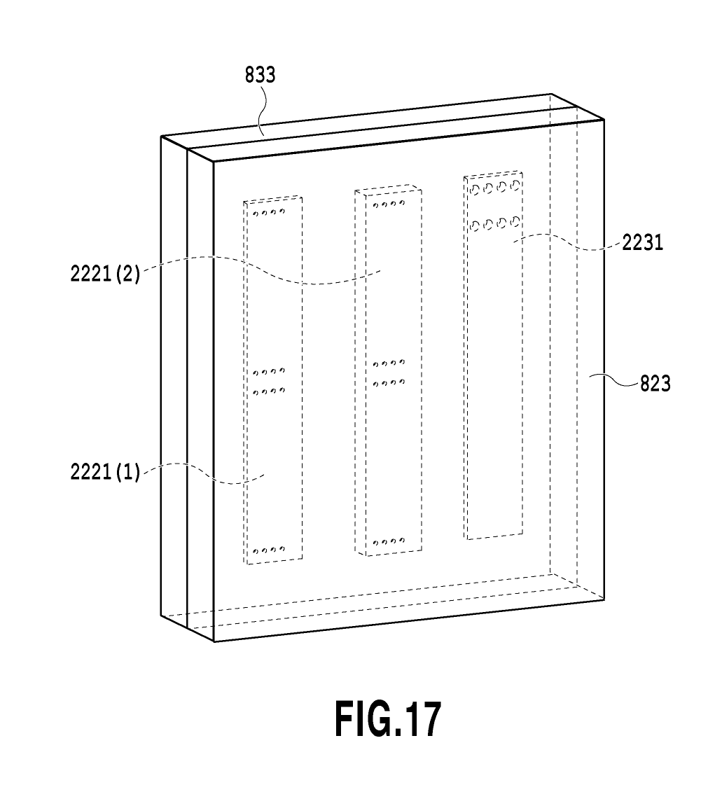

The present invention is also effective in a case of injection molding three or more components (inclusive of respective passage forming members) constituting a liquid supply unit in the same mold, and bonding the components to one another. As with the embodiments described above, the multiple components are injection molded simultaneously in the same mold, then the components are brought into contact with one another, and then a bonding material (a sealing material) is filled therein. Thus, it is possible to manufacture the liquid supply unit 220 by bonding the components to one another. As shown in FIG. 17, for example, the liquid supply unit 220 can be manufactured at the same time by injection molding three components, namely, passage forming members 2221(1) and 2221(2) and the passage lid member 2231, and then bonding the components to one another by using the bonding material. In this case, the three components may be bonded to one another at the same time, or separately in two steps of bonding two of the components to each other in advance and then bonding the last one thereto. Of the three components to be bonded, two components are preferably bonded to each other while being left on the mold.

The present invention is widely applicable to a method of manufacturing liquid supply units which supply various liquids, and a method of manufacturing liquid ejecting heads capable of ejecting various liquids. Meanwhile, the present invention is also applicable to methods of manufacturing liquid supply units and liquid ejecting heads which supply and eject liquids used for performing various treatments (printing, processing, coating, and the like) on various media (such as sheets). Examples of the medium (inclusive of printing medium) therefor include various medium made of any materials such as paper, plastic, film, fabric, metal, and flexible substrate, to which various liquids inclusive of inks are to be attached.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-228084 filed Nov. 24, 2016, which is hereby incorporated by reference wherein in its entirety.

What is claimed is:

1. A method of manufacturing a liquid supply unit to form a liquid passage to supply a liquid to a liquid ejecting head, comprising:
a molding step of injection molding at least a first member, which constitutes the liquid supply unit together with a second member, by using an injection mold including first and second molds being made openable and closable;
a mold opening step of opening the first and second molds while leaving the first member, which is injection molded in the molding step, on the first mold; and
a first bonding step of bonding a third member constituting the liquid supply unit to the first member left on the first mold.

2. The method of manufacturing a liquid supply unit according to claim 1, wherein
the first and second members are injection molded in the molding step, and
the first and second molds are opened in the mold opening step, while leaving the first member, injection molded in the molding step, on the first mold and leaving the second member, injection molded in the molding step, on the second mold.

3. The method of manufacturing a liquid supply unit according to claim 2, further comprising:
a moving step of, after the mold opening step and before or after the first bonding step, relatively moving the first and second molds such that the first member left on the first mold and the second member left on the second mold are opposed to each other; and
a second bonding step of, after the first bonding step and the moving step, closing the first and second molds, and bonding the second member left on the second mold to the first member being left on the first member and having the third member bonded thereto.

4. The method of manufacturing a liquid supply unit according to claim 1, wherein
the first mold is a fixed mold, and
the second mold is a movable mold.

5. The method of manufacturing a liquid supply unit according to claim 1, wherein the first member is bonded to the third member by thermal welding in the first bonding step.

6. The method of manufacturing a liquid supply unit according to claim 1, wherein the third member is a filter located in the liquid passage.

7. The method of manufacturing a liquid supply unit according to claim 3, wherein a space between the first member and the second member is filled with a bonding material in the second bonding step.

8. The method of manufacturing a liquid supply unit according to claim 7, wherein
a projected area obtained when a bonding surface of the first member in contact with the bonding material is projected onto the second member is substantially equal to a projected area obtained when a bonding surface of the second member in contact with the bonding material is projected onto the first member.

9. The method of manufacturing a liquid supply unit according to claim 7, wherein the bonding material is a material different from a material of each of the first and second members.

10. The method of manufacturing a liquid supply unit according to claim 3, wherein a plane on which bonding surfaces of the first member and the third member are located is different from a plane on which bonding surfaces of the first member and the second member are located.

11. The method of manufacturing a liquid supply unit according to claim 3, wherein a filler is included in a material to form each of the first and second members.

12. A method of manufacturing a liquid ejecting head provided with a liquid supply unit, comprising:
a molding step of injection molding at least a first member, which constitutes the liquid supply unit together with a second member, by using an injection mold including first and second molds being made openable and closable;
a mold opening step of opening the first and second molds while leaving the first member, which is injection molded in the molding step, on the first mold;
a first bonding step of bonding a third member constituting the liquid supply unit to the first member left on the first mold; and
a second bonding step of bonding the second member to the first member having the third member bonded thereto in the first bonding step; and
a third bonding step of bonding a printing element board, which is configured to eject a liquid, to the members bonded in the second bonding step.
